(19) United States
(12) Patent Application Publication
(10) Pub. No.: US 2009/0113294 A1
(43) Pub. Date: Apr. 30, 2009

(54) PROGRESSIVE CAPTCHA

(75) Inventors: Mehul Sanghavi, Sunnyvale, CA (US); Shreyas Doshi, Mountain View, CA (US)

Correspondence Address: BEYER LAW GROUP LLP/YAHOO, PO BOX 1687, CUPERTINO, CA, 95015-1687, US

(73) Assignee: YAHOO! INC., Sunnyvale, CA (US)

(21) Appl. No.: 11/929,716

(22) Filed: Oct. 30, 2007

(51) Int. Cl. G06F 17/21

(52) U.S. Cl. 715/269

(57) ABSTRACT

Validating that a user is a human may be accomplished through various techniques. In one embodiment, a first portion of a captcha is displayed at a first time. A second portion of the captcha image is displayed on the display at a second time, wherein the second time is subsequent to the first time. In another embodiment, an interactive task is presented on a display for a user to perform. Then a captcha image is displayed on the display once the user completes the interactive task. In either embodiment, a user may be accepted as human if input from the user matches predefined input corresponding to the captcha image.

### BACKGROUND OF THE INVENTION

1. Field of the Invention

The present invention relates to network security. More particularly, the present invention relates to a progressive captcha.

2. Description of the Related Art

A captcha is a type of challenge-response test used in computing to determine whether or not the user is human. “Captcha” is an acronym for “Completely Automated Public Turing test to tell Computers and Humans Apart.” A captcha involves one computer (typically a server), which asks a user to complete a test. The test is designed so that a computer can generate and grade the test, but a computer should not be able to solve the test on its own. Because computers are unable to solve the captcha, any user entering a correct solution is presumed to be human.

Captchas have increased in popularity with the rise of the Internet. Malicious users can create automated processes (e.g., bots) to attempt to perform tasks that services would prefer be limited to human users. Such processes include registering for email accounts, downloading programs, and entering passwords.

A common type of captcha requires that the user type the letters of a distorted image, sometimes with the addition of an obscured sequence of letters or digits that appears on the screen. Because the test is administered by a computer, in contrast to the standard Turing test that is administered by a human, a captcha is sometimes described as a reverse Turing test.

A key challenge in designing captchas is ensuring successful readability of the text by legitimate users. Any difficult design that attempts to thwart character recognition software will also be difficult for humans to read. Most networks use captcha images that employ distorted alphabets, numbers, alphanumeric, or random characters as part of the image. Additionally, the image might have squiggly lines and some color coding to make the text harder to read.

FIG. 1 depicts examples of traditional captchas.

### SUMMARY OF THE INVENTION

Validating that a user is a human may be accomplished through various techniques. In one embodiment, a first portion of a captcha is displayed at a first time. A second portion of the captcha image is displayed on the display at a second time, wherein the second time is subsequent to the first time. In another embodiment, an interactive task is presented on a display for a user to perform. Then a captcha image is displayed on the display once the user completes the interactive task. In either embodiment, a user may be accepted as human if input from the user matches predefined input corresponding to the captcha image.

### BRIEF DESCRIPTION OF THE DRAWINGS

FIG. 1 depicts examples of traditional captchas.

FIG. 2A is a diagram illustrating a progressive captcha in accordance with an embodiment of the present invention.

FIG. 2B is a diagram illustrating a progressive captcha in accordance with another embodiment of the present invention.

FIG. 3 is a diagram illustrating one version of a scratch pad progressive captcha in accordance with an embodiment of the present invention.

FIG. 4 is a diagram illustrating another version of a scratch pad progressive captcha in accordance with an embodiment of the present invention.

FIG. 5 is a diagram illustrating an example of a puzzle in accordance with an embodiment of the present invention.

FIG. 6 is a flow diagram illustrating a method for validating that a user is human in accordance with an embodiment of the present invention.

FIG. 7 is a flow diagram illustrating a method for validating that a user is a human in accordance with another embodiment of the present invention.

FIG. 8 is a flow diagram illustrating a method for validating that a user is a human in accordance with another embodiment of the present invention.

FIG. 9 is a flow diagram illustrating a method for validating that a user is a human in accordance with another embodiment of the present invention.

FIG. 10 is an exemplary network diagram illustrating some of the platforms that may be employed with various embodiments of the invention.

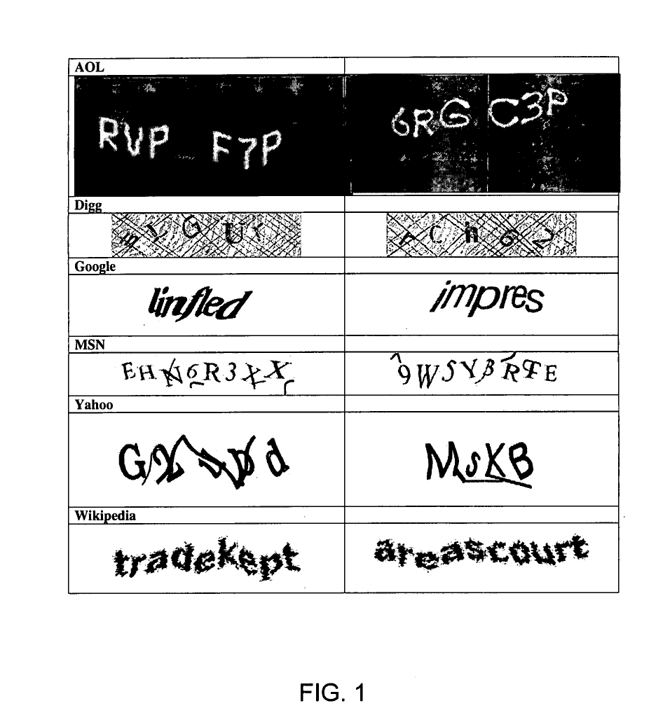

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

In accordance with the present invention, the components, process steps, and/or data structures may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

Through the inventive process, it was unexpectedly discovered that abusers who attack larger Internet networks, faced with more difficult to crack captcha designs that thwart OCR software, have been employing low-cost human labor in poorer countries to handle captchas. It was also discovered that the success rate in farming accounts to such countries is directly proportional to the time spent in reading and cracking the captchas. These operations are highly commoditized and price sensitive. Any changes in the amount of time spent per captcha will significantly jeopardize the abusers' operations and the ability to farm millions of accounts.

For example, it was unexpectedly discovered by the inventors that outsourcing web sites list offers to register accounts (which includes the solving of captchas) at a rate of about $50-$100 for every 1000 accounts registered—about 5-10 cents per account. There are also offers to simply solve captchas for even lower, roughly 0.2 cents-0.4 cents per captcha. Other bidders offer the already-registered identifications instead of bidding on the work. The inventors unexpectedly discovered that these identifications are selling for $10 for 1500 identifications, or 0.7 cents per identification. With such low price points, if the cost of solving the captcha were to increase by even just a penny per captcha, the amount of profit in solving captchas would decrease significantly.

As such, in an embodiment of the present invention, the captcha is designed to slow down the code entry process. This can be accomplished by various means. The general goal is to provide a level of delay that would make the farming of large numbers of accounts costly enough such that such practices are reduced or eliminated.

In one embodiment of the present invention, the captchas may be described as “progressive” captchas, because they do not reveal the entire captcha to the user at once, but rather do so slowly and/or in multiple pieces. The term “progressive” shall be interpreted to apply to any captcha whose display is intentionally delayed.

There are at least two general categories of progressive captchas in accordance with embodiments of the present invention. A first category involves displaying the captcha in multiple pieces over time. A second category involves providing some sort of interactive task for the user to perform prior to the captcha being displayed. Other categories of progressive captcha are also possible. Elements of each of these categories may be combined. For example, the progressive captcha may be displayed in multiple pieces over time but only once an interactive task has been performed.

In one embodiment of the present invention, the captcha is revealed as a sequence of pieces. For example, if the captcha solution is a word that the user needs to type in, then the captcha may reveal one letter at a time to the user. Subsequent characters may be displayed when the user types in the previous character or alternatively subsequent characters may simply appear on screen after designated times.

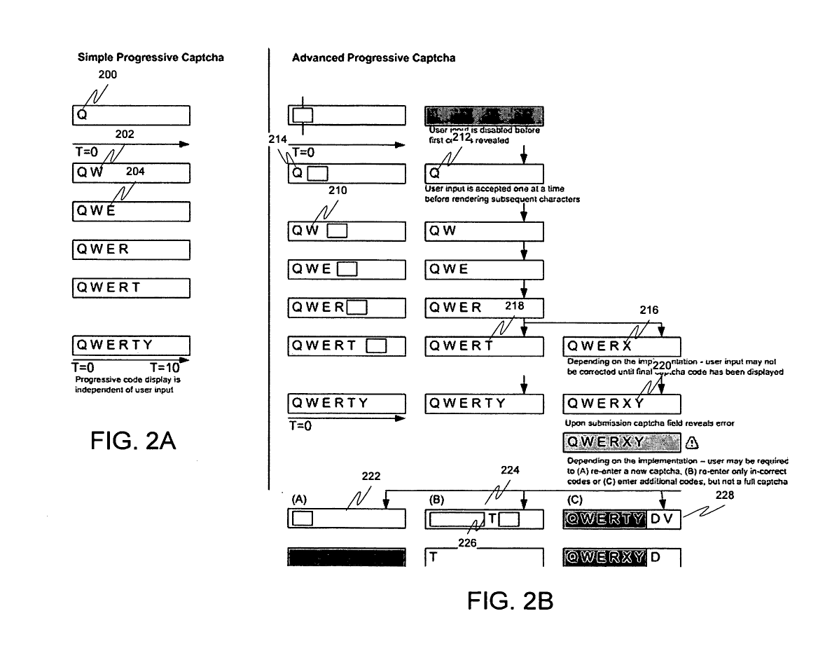

FIG. 2A is a diagram illustrating a progressive captcha in accordance with an embodiment of the present invention. It should be noted that the characters in this captcha are presented without the shading, partial obscuring, and/or shaping that is common with captcha images, in order to improve readability of this document. One of ordinary skill in the art will recognize that in practice the captchas will contain some level of alteration from ordinary-looking characters in order to prevent character recognition programs from deciphering the characters.

Here characters from the captcha are displayed after designated times. For example, the first character 200 may be displayed at Time 0, the second character 202 at time 1, the third character 204 at time 2, and so on. These times are, of course, only exemplary, and there is no requirement that the times be selected as preset intervals or times. For example, there may be a one second delay between the first and second character and a two second delay between the second and third character. Additionally, implementations are foreseen wherein the delay between the displaying of portions of the captchas is randomly or pseudo-randomly selected.

FIG. 2B is a diagram illustrating a progressive captcha in accordance with another embodiment of the present invention. As with FIG. 2A, the characters in this captcha are presented without the shading, partial obscuring, and/or shaping that is common with captcha images, in order to improve readability of this document. In this embodiment, each character of the captcha is displayed only once the previous character has been input by the user. For example, the second character 210 is only displayed after the user inputs character 212 in response to the display of first character 214.

It should be noted that this embodiment may be implemented in different ways, with respect to when the user's input is verified. In FIG. 2B, the user has accidentally input a fifth character 216 incorrectly. The fifth character 218 of the captcha is the letter “T,” but the user has typed “X.” One way to handle this is for the system to check each character as it is typed, resulting in an error condition. This error condition may then be passed on to the user in the form of an error message or some other means for altering the user as to the error. The user may then be given the opportunity to correct this error.

Alternatively, the system may only check the characters once the entire captcha has been displayed. Here, the user continues to type the sixth character 220 correctly. At this point the system detects the error and an error condition ensues. FIG. 2B depicts three possible ways in which this error condition is handled. 222 depicts the user being required to enter an entirely new captcha (no new captcha is depicted in FIG. 2B, but the old captcha has been erased). 224 depicts the user being required to re-enter only characters that have been entered incorrectly. In FIG. 2B, the captcha image 226 is also truncated such that only the portion that was entered correctly is displayed. 228 depicts the user being required to enter additional characters from a partial captcha 230.

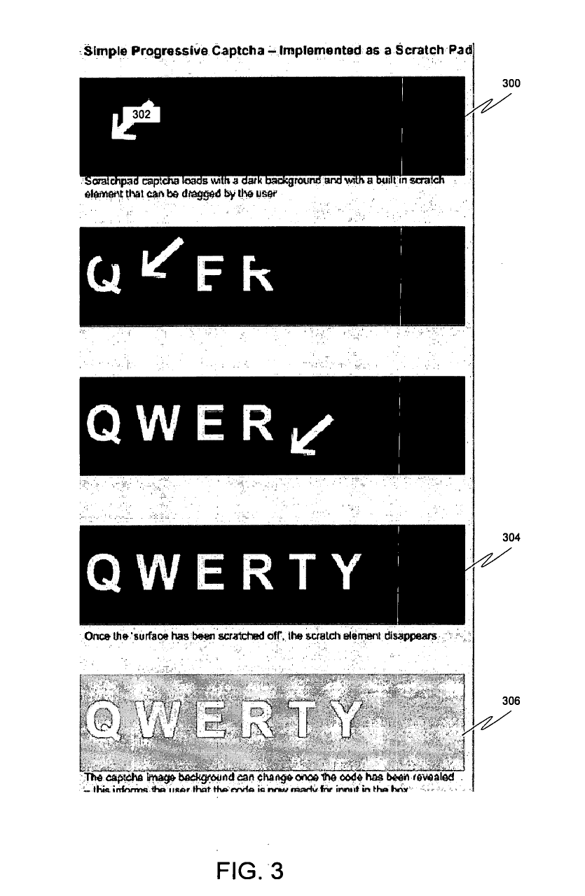

In another embodiment of the present invention, the captcha is implemented as a scratch pad. A scratch pad in computer terminology refers to a graphical interface in which the user “scratches” away something on the screen using a navigation device to reveal obscured underlying information. At load time, the captcha displays a partially or fully covered image. A user needs to use the mouse or pointing device to “scratch off” the covered areas to reveal the code. FIG. 3 is a diagram illustrating one version of a scratch pad progressive captcha in accordance with an embodiment of the present invention. In this version, a dark background 300 is presented with a built-in scratch element 302 that can be dragged by the user. The user continues to move the mouse back and forth until the entire captcha is revealed. Once the entire captcha is revealed the scratch element 302 may disappear (as displayed in 304), and the captcha image background can change (as displayed in 306). This indicates to the user that the user may now enter the characters in the input box.

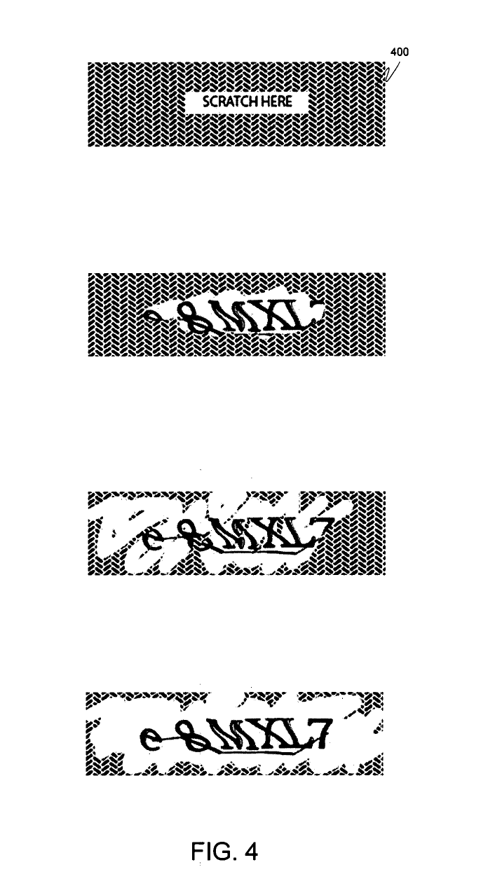

FIG. 4 is a diagram illustrating another version of a scratch pad progressive captcha in accordance with an embodiment of the present invention. In this version, a medium-shade background 400 is used and the user moves the mouse back and forth to slowly reveal the characters underneath. In this embodiment, the user may enter the characters in the input box at any time, and does not need to wait until the entire captcha is revealed to begin entering text. This embodiment resembles common user-friendly non-electronic “scratch off” games, such as those found on lottery tickets and promotional contests.

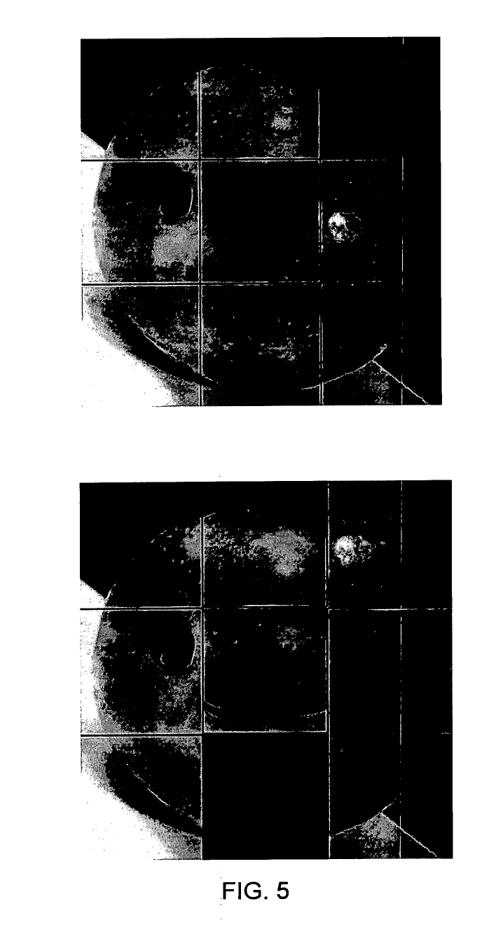

In another embodiment of the present invention, a user may be presented with an interactive task, which may be required to be performed prior to the captcha being revealed. This interactive task may be, for example, a puzzle or game that needs to be solved or won prior to the captcha being revealed. FIG. 5 is a diagram illustrating an example of a puzzle in accordance with an embodiment of the present invention. Here, a user must move squares making up a portion of a commonly-known image (in this case, an apple) to assemble the picture. The puzzle may or may not contain elements of the captcha itself. For example, in one embodiment of the present invention, a character-based captcha may be displayed following the user assembling the picture of the apple, and the character-based captcha may have nothing to do with apples. In another embodiment of the present invention, the puzzle may be the captcha itself. In this case, the user may be required to enter the word “apple” in the text box, without ever seeing a character-based captcha including the word “apple.” In another embodiment of the present invention, a combination of these techniques may be utilized. For example, following the user's solution of the apple puzzle, a character-based captcha may depict the characters “p-i-e”. Thus, the user is expected to type “apple pie” into the text box in order to solve the captcha and prove that the user is human.

In one embodiment, the captcha is designed to try to amuse legitimate users who might otherwise give up if the captchas are difficult to access. This embodiment recognizes that delays or interactive tasks that are boring or frustrating to the user will result in a significant percentage of users deciding against continuing with the very service the system is trying to promote. Since such “drop-outs” can be as or more destructive than illegitimate users gaining access to the service, it is important in some embodiments to ensure that users are not bored or frustrated through the attempts to determine whether or not they are human.

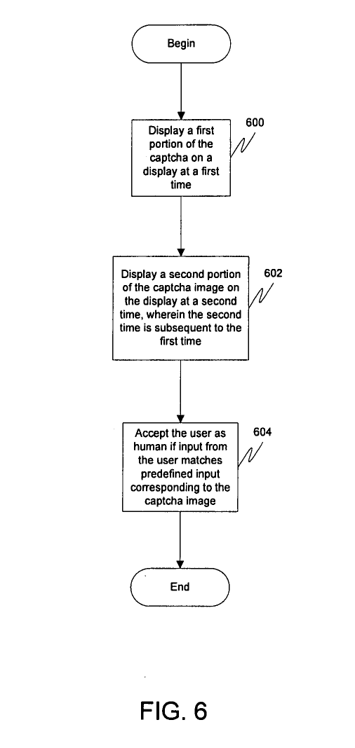

FIG. 6 is a flow diagram illustrating a method for validating that a user is human in accordance with an embodiment of the present invention. Each step of the method may be performed in hardware, software, or any combination thereof. At 600, a first portion of a captcha image is displayed on a display at a first time. At 602, a second portion of the captcha image is displayed on the display at a second time, wherein the second time is subsequent to the first time. The difference between the first time and the second time may be a preset delay time, or may be random or pseudo-random. Alternatively, the difference between the first time and the second time may be variable depending upon when the user performs a certain act. For example, the displaying of the second portion of the captcha image may not be performed until input is received from the user in response to the displaying of the first portion of the captcha image. Furthermore, this input may be checked as it is received and if the input does not match predefined input corresponding to the first portion of the captcha image then the displaying of the second portion of the captcha image may not be performed or may be delayed until the user corrects the error. In another embodiment, a visual indicator that the captcha is complete may be displayed when every portion of the captcha image has been sent from the server to the client.

At 604, the user is accepted as human if input from the user matches predefined input corresponding to the captcha image. The input from the user may be of various different forms, including the typing of one or more characters on a keyboard and movement of a pointing device such that a cursor crosses an area of the display corresponding to the second portion of the captcha image. The latter embodiment is commonly known as a “scratch pad.” In one embodiment, if the user input contains any errors, then the entire method may be repeated with a different captcha image. Alternatively, only the portion of the captcha image corresponding to the error may be displayed again and the user may be required to enter the correct input corresponding to that portion of the captcha image prior to being accepted as human.

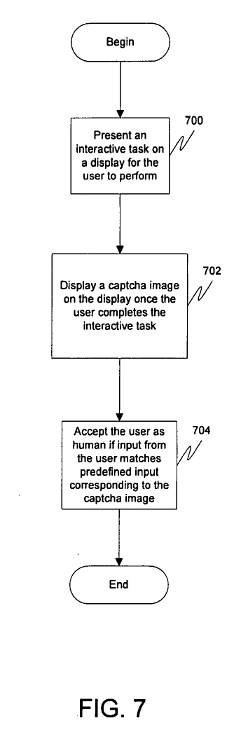

FIG. 7 is a flow diagram illustrating a method for validating that a user is a human in accordance with another embodiment of the present invention. Each step of the method may be performed in hardware, software, or any combination thereof. Here, at 700, an interactive task is presented on a display for the user to perform. The interactive task may be, for example, a puzzle or game. At 702, a captcha image is displayed on the display once the user completes the interactive task. At 704, the user is accepted as human if input from the user matches predefined input corresponding to the captcha image. The input from the user may be of various different forms, including the typing of one or more characters on a keyboard and movement of a pointing device such that a cursor crosses an area of the display corresponding to the second portion of the captcha image.

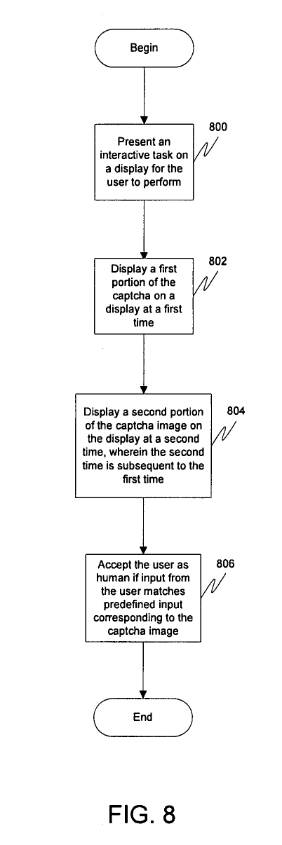

FIG. 8 is a flow diagram illustrating a method for validating that a user is a human in accordance with another embodiment of the present invention. Each step of the method may be performed in hardware, software, or any combination thereof. This embodiment is hybrid of the embodiments of FIGS. 6 and 7. At 800, an interactive task is presented on a display for the user to perform. The interactive task may be, for example, a puzzle or game. At 802, a first portion of a captcha image is displayed on a display at a first time. At 804, a second portion of the captcha image is displayed on the display at a second time, wherein the second time is subsequent to the first time. The difference between the first time and the second time may be a preset delay time, or may be random or pseudo-random. Alternatively, the difference between the first time and the second time may be variable depending upon when the user performs a certain act. For example, the displaying of the second portion of the captcha image may not be performed until input is received from the user in response to the displaying of the first portion of the captcha image. Furthermore, this input may be checked as it is received and if the input does not match predefined input corresponding to the first portion of the captcha image then the displaying of the second portion of the captcha image may not be performed or may be delayed until the user corrects the error. In another embodiment, a visual indicator that the captcha is complete may be displayed when every portion of the captcha image has been sent from the server to the client.

At 806, the user is accepted as human if input from the user matches predefined input corresponding to the captcha image. The input from the user may be of various different forms, including the typing of one or more characters on a keyboard and movement of a pointing device such that a cursor crosses an area of the display corresponding to the second portion of the captcha image.

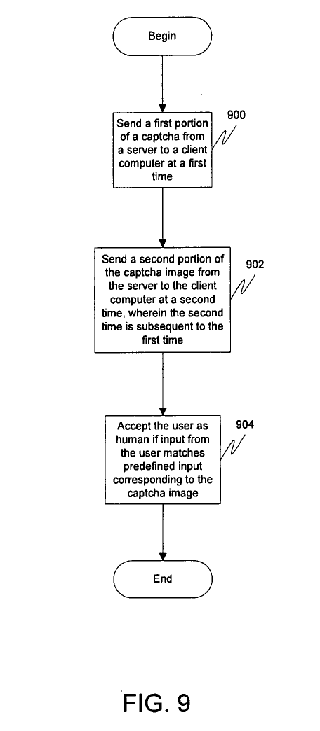

FIG. 9 is a flow diagram illustrating a method for validating that a user is a human in accordance with another embodiment of the present invention. Each step of the method may be performed in hardware, software, or any combination thereof. This embodiment shows steps undertaken by a server in a server-client relationship. Here, at 900, a first portion of a captcha image is sent from a server to a client computer at a first time. Then at 902, a second portion of the captcha image is sent from the server to the client computer at a second time, wherein the second time is subsequent to the first time. In one embodiment, input may be received from the user corresponding to the first portion of the captcha image at a third time subsequent to the first time but prior to the second time. Then it may be determined that the input from the user corresponding to the first portion of the captcha image contains an error. In such a case, step 904 may be delayed until the user corrects the error in the input corresponding to the first portion of the captcha image.

The difference between the first time and the second time may be a preset delay time, or may be random or pseudo-random. Alternatively, the difference between the first time and the second time may be variable depending upon when the user performs a certain act. For example, the sending of the second portion of the captcha image may not be performed until input is received from the user in response to the displaying of the first portion of the captcha image. Furthermore, this input may be checked as it is received and if the input does not match predefined input corresponding to the first portion of the captcha image then the sending of the second portion of the captcha image may not be performed or may be delayed until the user corrects the error. In another embodiment, a visual indicator that the captcha is complete may be sent from the server to the client computer when every portion of the captcha image has been sent from the server to the client. At 904, the user is accepted as human if input from the user matches predefined input corresponding to the captcha image. The input from the user may be of various different forms, including the typing of one or more characters on a keyboard and movement of a pointing device such that a cursor crosses an area of the display corresponding to the second portion of the captcha image.

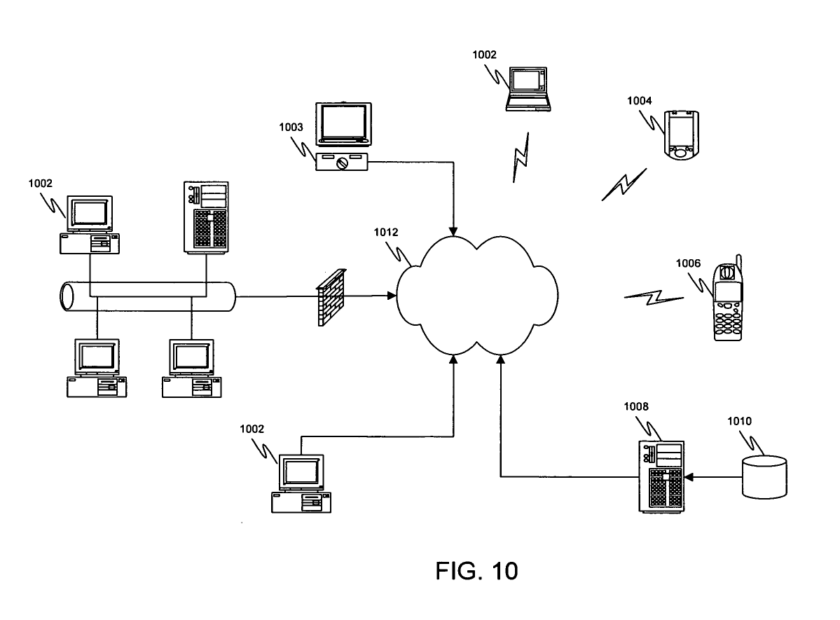

It should also be noted that embodiments of the present invention may be implemented on any computing platform and in any network topology in which presentation of search results is a useful functionality. For example and as illustrated in FIG. 10, implementations are contemplated in which the invention is implemented in a network containing personal computers 1002, media computing platforms 1003 (e.g., cable and satellite set top boxes with navigation and recording capabilities (e.g., Tivo)), handheld computing devices (e.g., PDAs) 1004, cell phones 1006, or any other type of portable communication platform. Users of these devices may navigate the network and enter input in response to the displaying of captcha on local displays, and this information may be collected by server 1008. Server 1008 (or any of a variety of computing platforms) may include a memory, a processor, and a communications component and may then utilize the various techniques described above. The processor of the server 1008 may be configured to run, for example, all of the processes described in FIG. 9. Any of the client devices 1002, 1003, 1004, 1006 may be configured to run, for example, all of the processes described in FIG. 6, 7, or 8. Server 1008 may be coupled to a database 1010, which may store the predefined inputs corresponding to captchas. Applications may be resident on such devices, e.g., as part of a browser or other application, or be served up from a remote site, e.g., in a Web page (also represented by server 1008 and database 1010). The invention may also be practiced in a wide variety of network environments (represented by network 1012), e.g., TCP/IP-based networks, telecommunications networks, wireless networks, etc. The invention may also be tangibly embodied in one or more program storage devices as a series of instructions readable by a computer (i.e., in a computer readable medium).

While the invention has been particularly shown and described with reference to specific embodiments thereof, it will be understood by those skilled in the art that changes in the form and details of the disclosed embodiments may be made without departing from the spirit or scope of the invention. In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A method for validating that a user is a human, the method comprising:
displaying a first portion of a captcha image on a display at a first time;
displaying a second portion of the captcha image on the display at a second time, wherein the second time is subsequent to the first time; and
accepting the user as human if input from the user matches predefined input corresponding to the captcha image.

2. The method of claim 1, wherein the difference between the first time and the second time is a preset delay time.

3. The method of claim 1, wherein the displaying a second portion of the captcha image is not performed until input is received from the user in response to the displaying of the first portion of the captcha image.

4. The method of claim 3, wherein the displaying a second portion of the captcha image is only performed if the input received from the user in response to the displaying of the first portion of the captcha image matches predefined input corresponding to the first portion of the captcha image.

5. The method of claim 3, wherein the input received from the user in response to the displaying of the first portion of the captcha image is the typing of one of one or more characters on a keyboard.

6. The method of claim 3, wherein the input received from the user in response to the displaying of the first portion of the captcha image is the movement of a pointing device such that a cursor crosses an area of the display corresponding to the second portion of the captcha image.

7. The method of claim 3, further comprising:
detecting an error in the input received from the user in response to the displaying of the first portion of the captcha image; and
delaying displaying of the second portion of the captcha image until the user corrects the error.

8. The method of claim 1, further comprising:
detecting an error in the input from the user; and
reperforming the method for validating using a different captcha image in response to the detecting an error.

9. The method of claim 1, further comprising:
detecting an error in the input from the user;
redisplaying the portion of the captcha image corresponding to the error in the input from the user; and
requiring that the user re-enter input corresponding to the portion of the captcha image corresponding to the error in the input from the user before accepting the user as human.

10. A method for validating that a user is a human, the method comprising:
presenting an interactive task on a display for the user to perform;
displaying a captcha image on the display once the user completes the interactive task; and
accepting the user as human if input from the user matches predefined input corresponding to the captcha image.

11. The method of claim 10, wherein the displaying includes:
displaying a first portion of a captcha image on a display at a first time; and
displaying a second portion of the captcha image on the display at a second time, wherein the second time is subsequent to the first time.

12. The method of claim 11, wherein the difference between the first time and the second time is a preset delay time.

13. The method of claim 11, wherein the displaying a second portion of the captcha image is not performed until input is received from the user in response to the displaying of the first portion of the captcha image.

14. A method for validating that a user is a human, the method comprising:
sending a first portion of a captcha image from a server to a client computer at a first time;
sending a second portion of the captcha image from the server to the client computer at a second time, wherein the second time is subsequent to the first time; and
accepting the user as human if input from the user matches predefined input corresponding to the captcha image.

15. The method of claim 14, further comprising:
receiving input from the user corresponding to the first portion of a captcha image at a third time subsequent to the first time but prior to the second time;
determining that the input from the user corresponding to the first portion of the captcha image contains an error; and
delaying sending the second portion of the captcha image from the server to the client computer until the user corrects the error in the input corresponding to the first portion of the captcha image.

16. The method of claim 14, further comprising:
sending a visual indicator that the captcha is complete from the server to the client computer when each portion of the captcha image has been sent from the server to the client.

17. A system comprising:
at least one computing device configured to:
receive a captcha image from a server; and
delay displaying the captcha image on a display by waiting until a user completes an interactive task and/or by displaying a first part of the captcha image at a first time and a second part of the captcha image at a second time, wherein the second time is subsequent to the first time.

18. The system of claim 17, wherein the difference between the first time and the second time is a preset delay time.

19. The system of claim 17, wherein the interactive task is a puzzle that must be solved by the user.

20. The system of claim 17, wherein input received from the user in response to the displaying of the first portion of the captcha image is the typing of one of one or more characters on a keyboard.

21. The system of claim 17, wherein input received from the user in response to the displaying of the first portion of the captcha image is the movement of a pointing device such that a cursor crosses an area of the display corresponding to the second portion of the captcha image.

22. An apparatus for validating that a user is a human, the apparatus comprising:
means for displaying a first portion of a captcha image on a display at a first time;
means for displaying a second portion of the captcha image on the display at a second time, wherein the second time is subsequent to the first time; and
means for accepting the user as human if input from the user matches predefined input corresponding to the captcha image.

23. The apparatus of claim 22, further comprising:
means for detecting an error in the input from the user; and
means for re-performing the method for validating using a different captcha image in response to the detecting an error.

24. The apparatus of claim 22, further comprising:
means for detecting an error in the input from the user;
means for redisplaying the portion of the captcha image corresponding to the error in the input from the user; and
means for requiring that the user re-enter input corresponding to the portion of the captcha image corresponding to the error in the input from the user before accepting the user as human.
